(19) United States
(12) Patent Application Publication
(10) Pub. No.: US 2016/0176079 A1
(43) Pub. Date: Jun. 23, 2016

(54) FOAMING APPARATUS AND METHOD FOR SOLID-STATE MICROCELLULAR FOAMS

(71) Applicant: DART CONTAINER CORPORATION, MASON, MI (US)

(72) Inventors: KRISHNA NADELLA, REDMOND, WA (US); STEVE WOOLDRIDGE, MARYSVILLE, WA (US)

(21) Appl. No.: 14/972,895

(22) Filed: Dec. 17, 2015

Related U.S. Application Data
(60) Provisional application No. 62/093,726, filed on Dec. 18, 2014.

(51) Int. Cl. B29C 43/24

(52) U.S. Cl. CPC B29C 43/24

(57) ABSTRACT

An apparatus and method are provided herein for solid-state microcellular processing, wherein a gas-saturated solid thermoplastic web is fed into an enclosed processing system comprising a plurality of thermal rollers and nip rollers that work together to constrain the thermoplastic web while expanding it through a series of thermal rollers and nip pressure. By constraining the web and controlling its rate of expansion, the present invention is intended to produce microcellular thermoplastic webs with a uniform thickness and flat surface.

### CROSS-REFERENCE TO RELATED APPLICATIONS

This application claims the benefit of U.S. Provisional Application No. 62/093,726, filed Dec. 18, 2014, which is herein incorporated by reference in its entirety.

### TECHNICAL FIELD

The current invention describes an apparatus and method for use in solid-state microcellular thermoplastic processing. A gas-impregnated thermoplastic web is fed into a processing apparatus comprising a plurality of thermal rollers and nip rollers arranged in various configurations. As the web advances through the apparatus, it is exposed to the series of thermal rollers and nip pressure, thereby allowing the web to expand at a controlled rate. Each thermal roller is coupled with a nip roller to form a nip that keeps the thermoplastic web under tension as it expands. By constraining the thermoplastic web and controlling its rate of expansion, a microcellular thermoplastic web with a flat surface and uniform thickness may be produced.

### BACKGROUND

Solid-state microcellular expansion involves saturating a solid thermoplastic material with a high-pressure non-reacting gas (usually CO2 or N2) inside a pressure vessel. Over time the gas diffuses into the thermoplastic material to achieve a uniform gas concentration throughout. When the gas-saturated thermoplastic material is removed from the pressure vessel and brought to atmospheric pressure, a “supersaturated” specimen that is thermodynamically unstable due to the drop in solubility is produced. The thermoplastic material is then heated at a temperature just above the glass-transition temperature of the gas-soaked thermoplastic material, and the billions of microbubbles thus generated inside the thermoplastic material causes the material to expand in volume. The resultant microcellular thermoplastic material is then cut to size or thermoformed into the desired article of manufacture.

In order to obtain flat microcellular thermoplastic samples, various heating methods have been employed. For instance, the gas-saturated thermoplastic material may be expanded in an IR (infrared) oven. The thermoplastic material is loaded onto a bi-axial stretching frame used to keep the material flat as it expands during heating. The bi-axial stretching frame is located between the top and bottom heating panels of the IR oven and expands under controlled processing times and temperatures. In another instance, the gas-saturated thermoplastic material is expanded in a hot press consisting of a pair of upper and lower heating platens. The thermoplastic sheet is inserted in between the heating platens whereupon the platens vertically close on the sheet applying a determined amount of pressure and temperature to achieve a certain thickness while keeping the surfaces of the thermoplastic sheet flat as it expands.

Yet other methods of expansion are to feed a gas-saturated thermoplastic sheet or web through an air flotation or impingement oven for expansion. Nip rollers are oftentimes used to maintain tension in the web in order to minimize corrugation and to control for thickness as the web expands.

The current challenge to solid-state microcellular thermoplastic processing is the ability to consistently produce flat microcellular thermoplastic web or sheet. With existing methods using an air flotation or air impingement oven, the web or sheet tends to form an uneven, corrugated surface. In addition, the use of an air flotation or air impingement oven to blast the gas-saturated thermoplastic material with hot air causes the material to expand without the ability to control the expansion in a precise manner.

In an attempt to produce flat microcellular thermoplastic web or sheet for thermoforming purposes, the present invention provides for an apparatus and method that employ temperature controls and nip pressure to regulate the expansion of the thermoplastic material. Unlike the rapid expansion of the web or sheet observed in air ovens, the apparatus of this current invention subjects the thermoplastic web to a series of thermal rollers and nip pressure in order to expand the web under tension and at a controlled rate. It is believed that slowing down the rate of expansion and applying the right amount of tension to the thermoplastic material will help to address the problem of uneven surface deformation.

### SUMMARY OF THE INVENTION

In one aspect embodiments of the invention relate to a method of forming a continuous flat sheet from a gas-saturated thermoplastic web, the method comprising sequentially passing the thermoplastic web through multiple sets of heat and nip rollers having at least one of a) increasingly higher heating temperatures for the heat rollers, b) intermittently higher and lower temperatures for the heat rollers, or c) alternately higher and lower temperatures for the heat rollers, while applying a nip pressure to keep the web flat.

In another aspect embodiments of the invention relate to a method of forming a continuous flat sheet from a gas-saturated thermoplastic web, the method comprising sequentially altering the temperature of the web in stages while maintaining a tension on the web sufficient to constrain the expansion of the web in each stage to maintain a flat sheet.

In another aspect embodiments of the invention relate to an apparatus for producing a continuous flat sheet of thermoplastic material comprising multiple sets of sequentially arranged heat and nip rollers, with each set altering the tension of the web and applying a sufficient nip pressure to sequentially constrain the expansion of the web to form a flat sheet of uniform thickness.

### BRIEF DESCRIPTION OF THE DRAWINGS

FIG. 1 is a schematic view of an enclosed apparatus comprising a plurality of thermal and nip roller pairs arranged in a horizontal sequence, according to an embodiment of the invention.

FIG. 2 is a schematic view of an enclosed apparatus comprising a plurality of thermal and nip roller pairs arranged in a vertically sequenced stack, according to an embodiment of the invention.

FIG. 3 is a schematic view of an enclosed apparatus comprising a plurality of thermal and nip roller pairs arranged in two vertically sequenced stacks, according to an embodiment of the invention.

FIG. 4 is a schematic view of an enclosed apparatus comprising a plurality of thermal roller pairs arranged in a horizontal sequence, according to an embodiment of the invention.

FIG. 5 is a schematic view of a thermal roller, according to an embodiment of the invention.

### DESCRIPTION

A major challenge in commercial scale, solid-state microcellular thermoplastic processing is being able to consistently produce a flat sheet or web of microcellular thermoplastic material. It is not uncommon during expansion of a gas-impregnated thermoplastic material for the material to form an uneven surface marred by undesirable corrugations. The present invention corrects this and includes an apparatus for regulating expansion conditions, namely heating temperature and nip pressure, in order to allow the thermoplastic material to expand evenly to obtain a uniformly thick expanded material with a flat surface.

The apparatus comprises a system of pairs of thermal and nip rollers that are arranged in a horizontal or vertical orientation or some other arrangement intended to accomplish the purpose. Each pair of thermal and nip roller comprises a working pair that jointly defines a nip, a plurality of which a gas-saturated thermoplastic web is passed through. In addition, each pair of nip-forming thermal rollers is arranged in sets, (labeled “set” in the figures) each set comprising two proximate and identical thermal rollers of the same diameter and temperature in order that both sides of the thermoplastic web make contact with a thermal roller for the same length of time and at the same temperature.

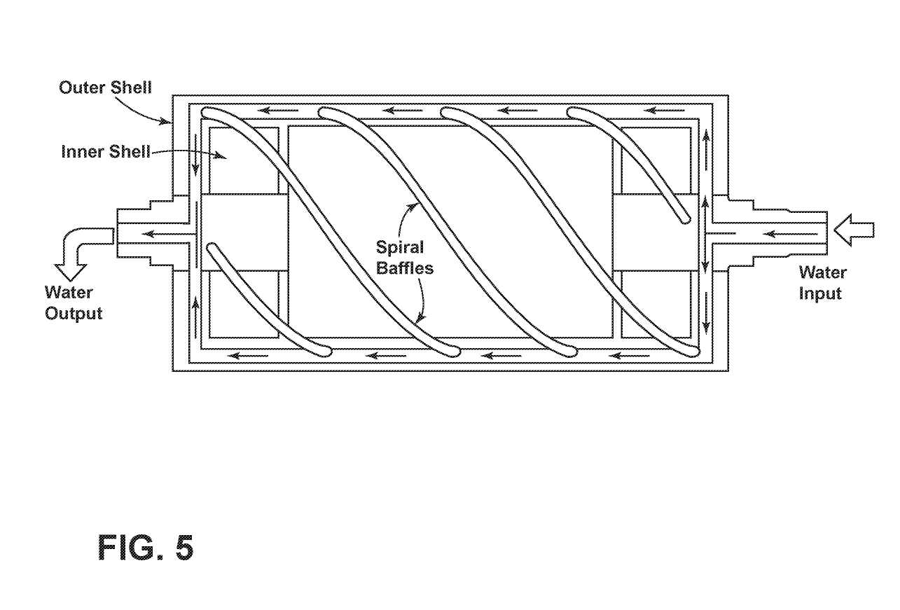

Each thermal roller can be individually adjusted to have a certain rotational speed and temperature. The thermal roller is mounted on an axle and rotatable about its own axis. Its temperature is also regulated by its own heating and cooling mechanism. Referring to FIG. 5, the thermal roller includes a hollow cylindrical roller comprising a rotating mantle whose outer surface may be heated or cooled by various means. For instance, in a self-contained closed-loop heating and cooling system, a heat-transfer liquid, is injected into the hollow core of the thermal roller from one end and travels through the length of the interior core of the roller, either through spiral grooves chiseled along the length of the interior mantle wall or through-holes drilled into the center of the roller, to exit out the other end where the liquid is then directed to a temperature control unit (TCU) to be reheated or cooled. The thermal roller may also be heated electrically with electrical resistors and conduits located in the center regions of the roller and powered by its own electrical heat source. (U.S. Pat. No. 6,486,448 to Juhani Niskanon et al.: “Method for Heating a Roll and a Heatable Roll”; U.S. Pat. No. 4,050,510 to Helmuth Theysohn: “Calendar Heating Roll,”). In such an electrically heated thermal roller, the cooling function can be accomplished in a heat-transfer liquid that is passed through different channels. In other instances, an external thermal source can also be employed to heat the thermal rollers to the desired temperature. Hence, the temperature of the thermal rollers are individually regulated such that each set of thermal rollers in the series of thermal rollers within the nip-forming rollers system has a higher or lower temperature than the set before it to allow the thermoplastic web to expand in a controlled manner and at a controlled rate. For example, the temperature of the first set of thermal rollers could he incrementally lower than the second set of thermal rollers, the second set is incrementally lower than the third set and so on, which can be inversely expressed as: T∞, . . . T₃>T₂>T₁. The temperature of each set of thermal rollers is so calculated that the increase in temperature of each successive set leads to the projected ideal peak temperature by the end of the series. In yet another example, the set of rollers whose temperature setting has an even subscript could be cooled and ones with an odd subscript could he heated and vice versa. It can be appreciated by those trained in the art that any combination of heating and cooling may be used to achieve controlled expansion resulting in a flat microcellular thermoplastic sheet or web.

To accommodate the growing dimensions of the thermoplastic material during expansion, each successive set of thermal rollers may be larger in diameter and/or have faster rotational speeds. The rotation of the thermal roller functions to advance the thermoplastic web at speeds calibrated to the web's projected expansion in the length direction. As the thermoplastic web is fed through the series of thermal and nip roller pairs, the temperature of each set of thermal rollers could be higher than the earlier sets in the series, thereby causing the web to expand at faster rates as it passes through the apparatus. The thermal rollers along the series are thus adjusted to rotate at faster speeds in order to accommodate the growing volume while avoiding potential bottlenecks in the system. Hence, the rotation speed of each set of thermal rollers can be expressed as: R∞ . . . R₃>R₂>R₁. Consequently, to offset the reduction in heating time with the faster rotating thermal rollers, each set of thermal rollers in the series may be larger in diameter to allow for more surface contact with the thermoplastic web, which can be expressed as: D∞ . . . D₃>D₂>D₁.

Each nip roller in every set of the apparatus is mounted on an axle and is directionally adjustable in order to achieve the amount of nip pressure required to keeping the thermoplastic web under tension. The nip roller can be moved up, down, (see arrow labeled 50) or sideways (see arrow labeled 52) depending on the orientation of the nip contact, in order to increase or decrease the amount of distance between the thermal and nip roller relative to the thermoplastic web sandwiched in between them, thereby defining the amount of nip pressure that is applied on the thermoplastic web. The desired nip pressure is determined by the amount of tension necessary to keeping the thermoplastic material flat and to achieving the desired uniform thickness. The amount of nip pressure must also take into account the growing thickness of the thermoplastic web as it is conveyed through the apparatus to avoid applying excessive compressive pressure, which could lead to unwanted surface markings or even densification of the thermoplastic material.

The series of nips formed by the several pairs of thermal and nip rollers serve to exert a certain amount of nip pressure necessary to keep the thermoplastic web as flat as possible as it expands. Each thermal and nip roller pair thus work in tandem to advance the web at a certain rotational speed and nip pressure to accommodate the expanding web while achieving the desired uniform thickness and even surface.

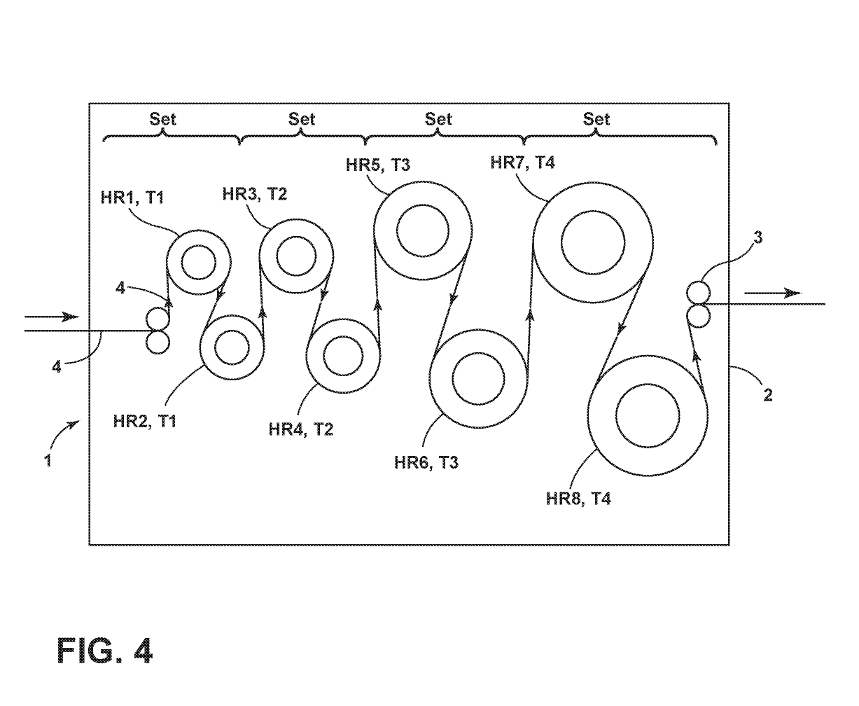

In other embodiments of the apparatus, the thermal roller may provide tension in the thermoplastic web that can replace the pressure provided by the nip rollers to keep the thermoplastic web as flat as possible while the web expands. For example, the apparatus shown in FIG. 4 does not include a nip roller. Instead, the thermal roller provides tension in the thermoplastic web to keep the thermoplastic web as flat as possible while it expands.

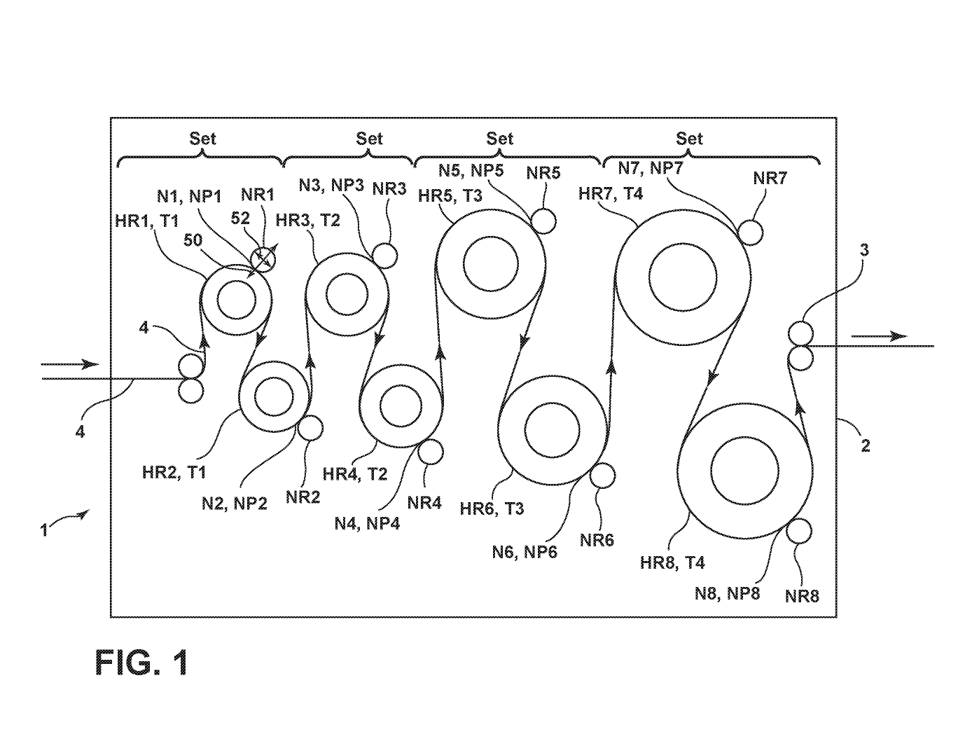

In an embodiment of the apparatus, FIG. 1 provides a schematic view of an enclosed system 1 of pairs of themlal and nip rollers arranged in a horizontal fashion. Each thermal and nip roller pair (HR1-NR1, HR2-NR2 . . . ) works jointly to form a nip with the desired nip pressure such that a thermoplastic web is fed through a plurality of such nips in a horizontally oriented sequence. The apparatus system 1 may be enclosed in a climate-control environment 2 in order to maintain the desired temperatures used to regulate the expansion rate of the thermoplastic web. The method of expanding the thermoplastic web involves conducting a gas-saturated thermoplastic web 4 to the first thermal roller HR1 of the first thermal-nip roller pair HR1-NR1 with the aid of guide rollers 3. The underside of the thermoplastic web is directly in contact with the first thermal roller HR1 at temperature T1, which could be of a sufficient temperature to initiate the first incremental expansion of the thermoplastic web. The first nip N1 formed from the first thermal-nip roller pair HR1-NR1 applies a certain amount of nip pressure NP1 sufficient to keep the web flat under tension as the web expands in the thickness and planar direction. The rotation of the first thermal roller HR1 of the thermal-nip roller pair HR1-NR1 advances the web to the second heating roll HR2 of the second thermal-nip roller pair HR2-NR2. This time the upper side of the thermoplastic web is exposed directly to the surface of the second thermal roller HR2 at the same temperature T1 to initiate the second expansion stage of the thermoplastic web. The second nip N2 of the second thermal-nip roller pair HR2-NR2 applies nip pressure NP2 on the thermoplastic web to keep the web flat as it expands. The rotation of the second thermal roller HR2 advances the web to the third thermal roller HR3 of the third thermal-nip roller pair HR3-NR3, and so on, repeating the same steps of advancing the thermoplastic web through the series of thermal-nip roller pairs: (1) whereby both sides of the web are alternately exposed to the same heating or cooling temperatures as the web advances to the sets of thermal rollers; (2) whereby the thermoplastic web is constrained by nips that exert a required amount of nip pressure to keep the thermoplastic web flat while accounting for the web's growing thickness: and (3) whereby the web is advanced by thermal rollers that are in most instances larger in size and rotate at faster speeds than the ones before them to accommodate the web's expansion. Once the thermoplastic web has moved through the series of thermal and nip rollers, the thermoplastic web exits the apparatus where it is rewound or is sent directly to a thermoformer.

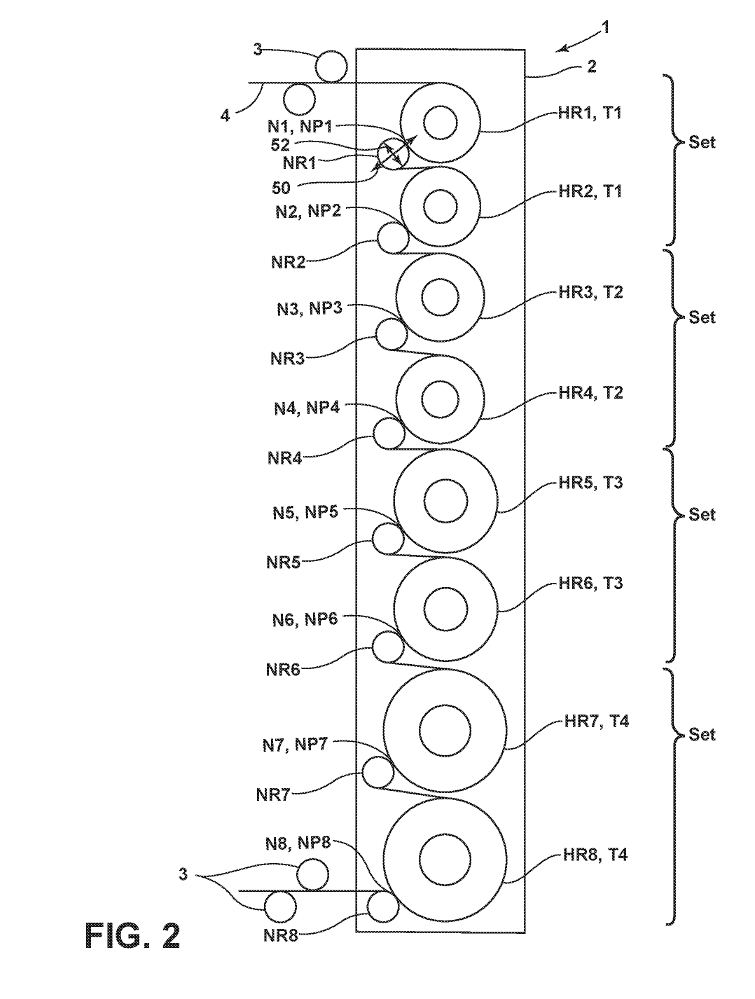

In another embodiment of the apparatus, FIG. 2 provides a schematic view of a nip pressure system 1 comprising several pairs of heating and nip rollers arranged in a vertical stack and enclosed in a climate-control environment 2. Each thermal-nip roller pair jointly forms a nip through which the thermoplastic web passes in a series of such nips in a vertically oriented sequence. With the aid of guide rollers 3, the gas-saturated thermoplastic web 4 is conducted to the first thermal roller HR1 of the first thermal-nip roller pair HR1-NR1. The underside of the thermoplastic web is exposed to the first thermal roller HR1 at temperature T1 and the first nip N1 at nip pressure NP1 of the first thermal-nip roller pair HR1-NR1 to start off the first expansion stage. The rotation of the first thermal roller HR1 advances the web to the second thermal roller HR2 of the second thermal-nip roller pair HR2-NR2, where the upper side of the thermoplastic web is exposed to the same temperature T1 of the second thermal roller HR2 and nip pressure NP2 of the second nip N2 of the second thermal-nip roller pair HR2-NR2 to begin the second expansion stage. The rotation of the second thermal roller HR2 advances the thermoplastic web to the third thermal roller HR3 of the third thermal-nip roller pair HR3-NR3, and so on. Once the thermoplastic web is expanded, it exits the apparatus and may be rolled up or thermoformed.

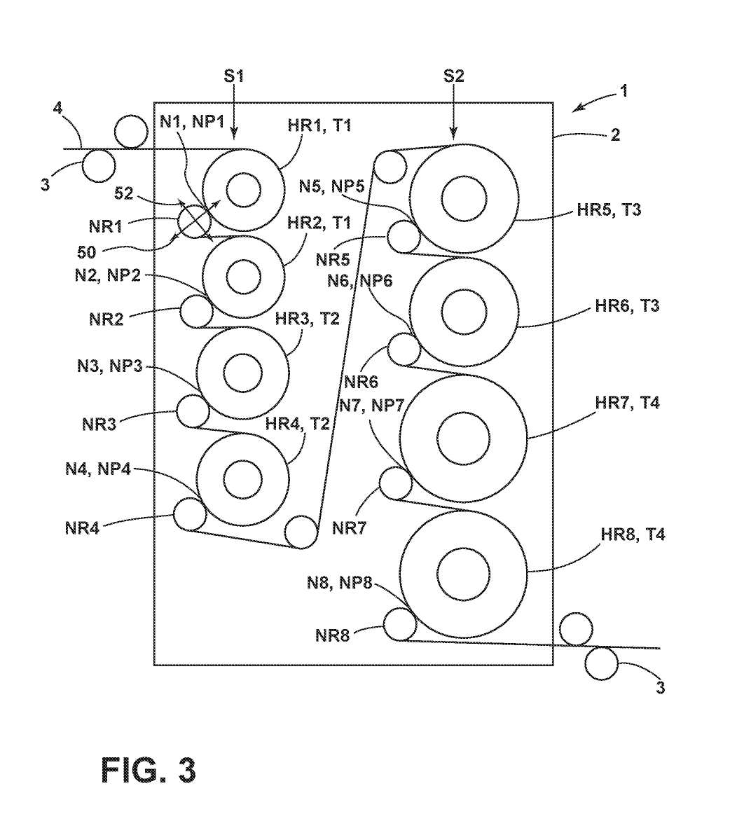

In yet another embodiment of the apparatus, FIG. 3 provides a view of a nip pressure system 1 arranged in two vertical stacks inside a temperature-control enclosure 2. With the aid of guide rollers 3, the gas-saturated thermoplastic web 4 is conducted to the first thermal roller HR1, where the underside of the web is exposed to temperature T1 of the first thermal roller HR1 and nip pressure NP1 of the first nip N1 of the first thermal-nip roller pair HR1-NR1 of the first stack S1 to initiate the first expansion stage. The rotation of the first thermal roller HR1 advances the thermoplastic web to the second thermal roller HR2 where the upper side of the thermoplastic web is exposed to the same temperature T1 of the second thermal roller HR2, nip pressure NP2 of the second nip N2 of the second thermal-nip roller pair HR2-NR2. The rotation of the second thermal roller HR2 advances the web to the third thermal roller HR3 at temperature T2, nip pressure NP3 of nip N3 of the third thermal-nip roller pair HR3-NR3, and so on. When the web has run through the first stack of thermal-nip roller pairs, it is conducted by guide rollers 3 to the second stack S2 and the same steps are repeated. Once thermoplastic web is expanded, it exits the apparatus and may be rolled up or thermoformed.

### NOVELTY

An apparatus and method that produces a continuous flat sheet of microcellular thermoplastic material in the solid-state.

The apparatus is designed to control certain processing conditions, namely temperature and nip pressure, to allow a gas-saturated thermoplastic web to expand in stages and under tension by exposing it to (1) increasingly higher heating temperatures or (2) intermittently higher and lower temperatures, or (3) other combinations of higher heating or lower cooling temperatures thereof while applying sufficient amount of nip pressure to keep the web flat and to achieve a certain uniform thickness. In order to maintain the right temperature conditions, the apparatus could be housed in a temperature-control enclosure.

The apparatus comprises a plurality of thermal and nip roller pairs assembled in a horizontal or vertical series or some other suitably oriented series.

Each thermal and nip roller pair forms a nip, is characterized by a certain amount of nip pressure applied on the thermoplastic web as it passes, and functions to constrain the web during expansion in order to keep the web flat and uniformly thick.

Each set of thermal rollers in the series of thermal-nip roller pairs is characterized by a certain temperature that could be higher or lower than the one before it in order to regulate expansion of the thermoplastic web at a controlled rate.

Each set of thermal rollers in the series of thermal-nip roller pairs is set at a certain rotation speed that tends to be faster than the one before it in order to accommodate the web's expansion by adjusting its running speed.

Each set of thermal rollers in the series of thermal-nip roller pairs is of a certain size diameter that tends to be larger than the one before it to ensure that even though the thermal rollers in the later series may be running at faster speeds, the web is experiencing the same amount of surface contact because the thermal rollers are larger in diameter.

The present invention provides a method for expanding a gas-saturated thermoplastic web in an apparatus that exposes the web to target temperatures as it advances through a series of thermal-nip roller pairs, whereby each thermal-nip roller pair subjects the thermoplastic web to a certain temperature, nip pressure, thermal contact and rotation speed to expand the thermoplastic web in stages and in a constrained manner.

1. A method of forming a continuous flat sheet from a gas-saturated thermoplastic web, the method comprising sequentially passing the thermoplastic web through multiple sets of heat and nip rollers having at least one of a) increasingly higher heating temperatures for the heat rollers, b) intermittently higher and lower temperatures for the heat rollers, or c) alternately higher and lower temperatures for the heat rollers, while applying a nip pressure to keep the web flat.

2. The method of claim 1 wherein the nip pressure is sufficient to achieve a uniform thickness of the web.

3. The method of claim 1 wherein the thermoplastic material has a microcellular structure.

4. The method of claim 1 wherein the passing the thermoplastic web through the multiple sets of heat and nip rollers is done within a temperature controlled enclosure.

5. The method of claim 1 wherein the speed of the web increases with each set of heat and nip rollers.

6. The method of claim 5 wherein the speed of the web increases by increasing at least one of the rotational speed of the heat roller or the diameter of the heat roller.

7. A method of forming a continuous flat sheet from a gas-saturated thermoplastic web, the method comprising sequentially altering the temperature of the web in stages while maintaining a tension on the web sufficient to constrain the expansion of the web in each stage to maintain a flat sheet.

8. The method of claim 7 wherein the tension is maintained to constrain the tension such that the web has a uniform thickness for each stage.

9. The method of claim 7 wherein the altering the temperature comprises sequentially increasing the temperature of the web for each stage.

10. The method of claim 7 wherein the altering the temperature comprises alternately increasing and decreasing the temperature of the web for each stage.

11. The method of claim 7 wherein the altering the temperature comprises alternately altering opposite sides of the web for each stage.

12. The method of claim 7 further comprising increasing the speed of the web for each stage.

13. The method of claim 7 wherein the sequentially altering the temperature of the web in stages is conducted within a temperature-controlled enclosure.

14. An apparatus for producing a continuous flat sheet of thermoplastic material comprising multiple sets of sequentially arranged heat and nip rollers, with each set altering the tension of the web and applying a sufficient nip pressure to sequentially constrain the expansion of the web to form a flat sheet of uniform thickness.

15. The apparatus of claim 14 wherein the temperature of the heating rollers increases with each set.

16. The apparatus of claim 14 wherein the temperature of the heating rollers intermittently changes with each set.

17. The apparatus of claim 14 wherein the temperature of the heating rollers alternately increases and decreases with adjacent sets.

18. The apparatus of claim 14 wherein the sets are arranged in one of horizontally or vertically.

19. The apparatus of claim 14 wherein the rotational speed of the sets increases to accommodate the expansion of the web.

20. The apparatus of claim 19 wherein the rotational speed increases with each set.

21. The apparatus of claim 19 wherein either the rotational speed and/or the diameter of the heat roller in each set increases with each set.

22. The apparatus of claim 14 wherein the diameter of the heat roller increases with the rotational speed of the heat roller.
